(19) United States
(12) Patent Application Publication
(10) Pub. No.: US 2018/0105409 A1
(43) Pub. Date: Apr. 19, 2018

(54) Tree Watering Device

(71) Applicant: John Bernaski, Amsterdam, NY (US)

(72) Inventor: John Bernaski, Amsterdam, NY (US)

(21) Appl. No.: 15/725,444

(22) Filed: Oct. 5, 2017

Related U.S. Application Data
(60) Provisional application No. 62/409,701, filed on Oct. 18, 2016.

(51) Int. Cl. B67C 11/04; A47G 33/12

(52) U.S. Cl. CPC B67C 11/04; A47G 2033/1286; A47G 33/12

(57) ABSTRACT

A tree watering device. The tree watering device includes an elongated body having a channel therethrough. A funnel having an open upper end is disposed on an upper end of the elongated body, wherein the funnel is in fluid communication with the channel. A hollow stake having an open lower end is disposed on a lower end of the elongated body, wherein the hollow stake is in fluid communication with the channel. A fastener disposed on the elongated body is configured to secure the elongated body to the tree. A valve disposed on the elongated body is configured to selectively allow water to flow from the funnel through the channel and out of the open lower end of the hollow stake for providing water to a tree such as a Christmas tree.

### CROSS REFERENCE TO RELATED APPLICATIONS

This application claims the benefit of U.S. Provisional Application No. 62/409,701 filed on Oct. 18, 2016. The above identified patent application is herein incorporated by reference in its entirety to provide continuity of disclosure.

### FIELD OF THE INVENTION

The present invention relates to plant care. More specifically, the present invention relates to a tree watering device for providing water to a Christmas tree.

### BACKGROUND OF THE INVENTION

Many individuals that celebrate Christmas do so by decorating a live tree and displaying it in the home. Live trees are often utilized due to their pleasing smell and natural appearance. However, live trees must be given water often, or else needles will fall from the tree or the tree will die. It can be difficult to access the base of the tree when watering, because the lower branches and needles extend far outward from the trunk area. Further, some individuals may have difficult bending over to access the tree stand. Pouring water through the upper branches of the tree can result in spilled water and an inadequately filled base. It is therefore desirable to provide a tree watering device having an easily accessible funnel that transports water directly to the base of the tree.

Devices have been disclosed in the known art that relate to tree watering devices. These include devices that have been patented and published in patent application publications. However, these devices have several drawbacks. Some devices in the known art are bulky and detract from the aesthetic appearance of the tree. Other devices fail to provide a valve for selectively applying water to the tree, so that a funnel portion may act as a reservoir that does not need constant refilling.

In light of the devices disclosed in the known art, it is submitted that the present invention substantially diverges in design elements from the known art and consequently it is clear that there is a need in the art for an improvement to existing tree watering devices. In this regard the present invention substantially fulfills these needs.

### SUMMARY OF THE INVENTION

In view of the foregoing disadvantages inherent in the known types of tree watering devices now present in the prior art, the present invention provides a tree watering device wherein the same can be utilized for providing convenience for the user when watering a Christmas tree. The present tree watering device comprises an elongated body having a channel therethrough. A funnel having an open upper end is disposed on an upper end of the elongated body, the funnel in fluid communication with the channel. A hollow stake having an open lower end is disposed on a lower end of the elongated body, the hollow stake in fluid communication with the channel. A fastener disposed on the elongated body is configured to secure the elongated body to a tree. A valve disposed on the elongated body and extending into the channel is configured to selectively allow water to flow from the funnel through the channel and out of the open lower end of the hollow stake.

One object of the present invention is to provide a tree watering device that allows users to easily and effectively water a Christmas tree.

Another object of the present invention is to provide a tree watering device that can be secured to a tree and obscured from view via the tree's foliage.

A further object of the present invention is to provide a tree watering device having a valve for selectively allowing water to flow to the base of the tree, so that the funnel portion may serve as a water reservoir that does not need constant refilling.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side view of the tree watering device.

FIG. 2A shows a top down view of the tree watering device with the valve in an open configuration.

FIG. 2B shows a top down view of the tree watering device with the valve in an open configuration.

FIG. 3A shows a top down view of an alternate embodiment of the tree watering device with the valve in an open configuration.

FIG. 3B shows a top down view of an alternate embodiment of the tree watering device with the valve in a closed configuration.

FIG. 4 shows a side view of the tree watering device secured to a tree.

### DETAILED DESCRIPTION OF THE INVENTION

Reference is made herein to the attached drawings. Like reference numerals are used throughout the drawings to depict like or similar elements of the tree watering device. For the purposes of presenting a brief and clear description of the present invention, the preferred embodiment will be discussed as used for watering a Christmas tree. The figures are intended for representative purposes only and should not be considered to be limiting in any respect.

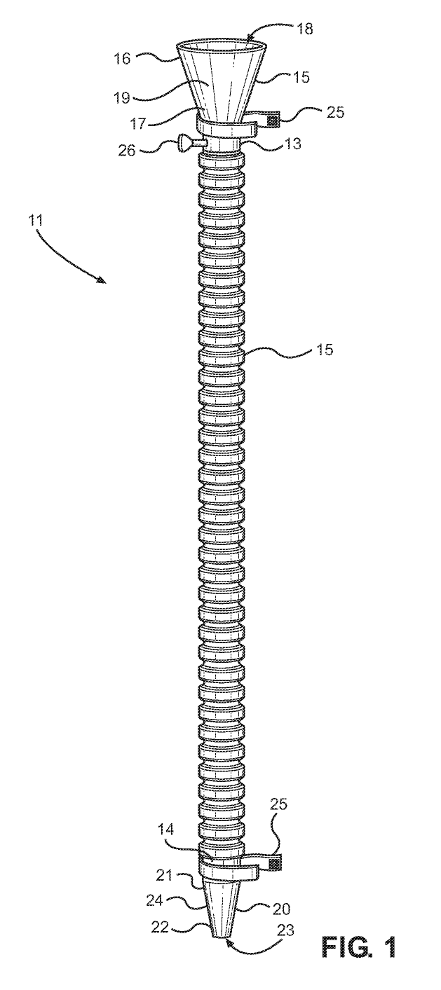

Referring now to FIG. 1, there is shown a side view of the tree watering device. The tree watering device 11 comprises an elongated body 12 having a channel therethrough, which is utilized to transport water to the base of a tree such as a Christmas tree. A funnel 15 having an upper opening 18 in fluid communication with the channel is disposed on an upper end 13 of the elongated body 15. A hollow stake 20 in fluid communication with the channel is disposed on a lower end 14 of the elongated body 12. In use, water travels from the funnel 15, through the channel along the length of the elongated body 15, and out of a lower opening 23 of the hollow stake 20, which is preferably positioned within the tree stand supporting the base of the tree to be watered.

The tree watering device 15 further comprises a valve 26 disposed on the elongated body 12 beneath the funnel 15. The valve is configured to selectively allow water to flow from the funnel 15 into the channel and out of the hollow stake 20. In this way, a user may pour water into the funnel 15 when the valve 26 is in a closed position, such that the funnel 15 serves as a reservoir storing water therein. The valve 26 can then be moved to an open position when watering the tree, permitting water to flow downward from the funnel 15 through the channel and out of the hollow stake 20.

In the shown embodiment, the funnel 15 includes a sidewall 19 that tapers inwardly from an upper end 16 to a lower end 17 thereof. Similarly, the hollow stake 20 includes a sidewall 24 that tapers inwardly from an upper end 21 to a lower end 22 thereof. The tapering of the funnel 15 allows more water to be poured therein, while the tapering the hollow stake 20 provides a decreased cross-sectional area, allowing the hollow stake 20 to be easily maneuvered and positioned between branches of the tree to be watered. To this end, the elongated body 12 comprises flexible tubing so that the elongated body 12 may be threaded through and around the various branches when securing the elongated body 12 to the tree.

The tree watering devices further comprises fasteners 25 configured to secure the elongated body 12 to the tree. In the shown embodiment, two fasteners 25 are utilized, with one fastener 25 affixed to the funnel 15 and one fastener 25 affixed to the hollow stake 20. The fasteners 25 may be affixed to the lower end 17 of the funnel and the upper end 21 of the hollow stake 20, so as not to interfere with the funnel upper opening 18 or the hollow stake lower opening 23. The fasteners 25 may comprise hook and loop material as shown, or may comprise any other suitable fasteners such as clips, hooks, snap straps, or the like.

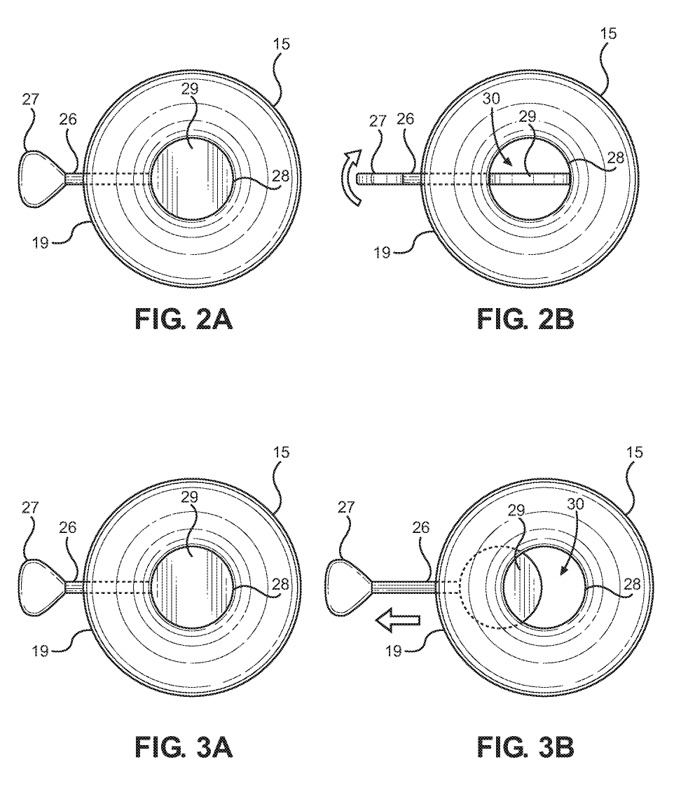

Referring now to FIGS. 2A and 2B, there is shown a top down view of the tree watering device with the valve in an open configuration and a top down view of the tree watering device with the valve in an open configuration, respectively. In one embodiment, the valve 26 is a rotatable valve comprising a handle 27 extending out of the sidewall 19 of the funnel 15 affixed to a stopper 29. When the valve 26 is in a closed position, the stopper 29 is flush with the inner wall 28 of the funnel, preventing water from exiting therethrough. The valve 26 is configured to rotate to an open position via rotation of the handle 27, as shown in FIG. 2B, such that water is then permitted to flow out of the funnel 15 and into the channel 30.

Referring now to FIGS. 3A and 3B, there is shown a top down view of an alternate embodiment of the tree watering device with the valve in an open configuration and a top down view of an alternate embodiment of the tree watering device with the valve in a closed configuration, respectively. In an alternate embodiment, the valve 26 is a pull-out valve comprising a handle 27 extending out of the sidewall 19 of the funnel 15 affixed to a stopper 29. When the valve 26 is in a closed position, the stopper 29 is flush with the inner wall 28 of the funnel, preventing water from exiting therethrough. The valve 26 is configured to translate to an open position via linear movement of the handle 27 in a direction opposing the funnel 15, as shown in FIG. 2B, such that water is then permitted to flow out of the funnel 15 and into the channel 30.

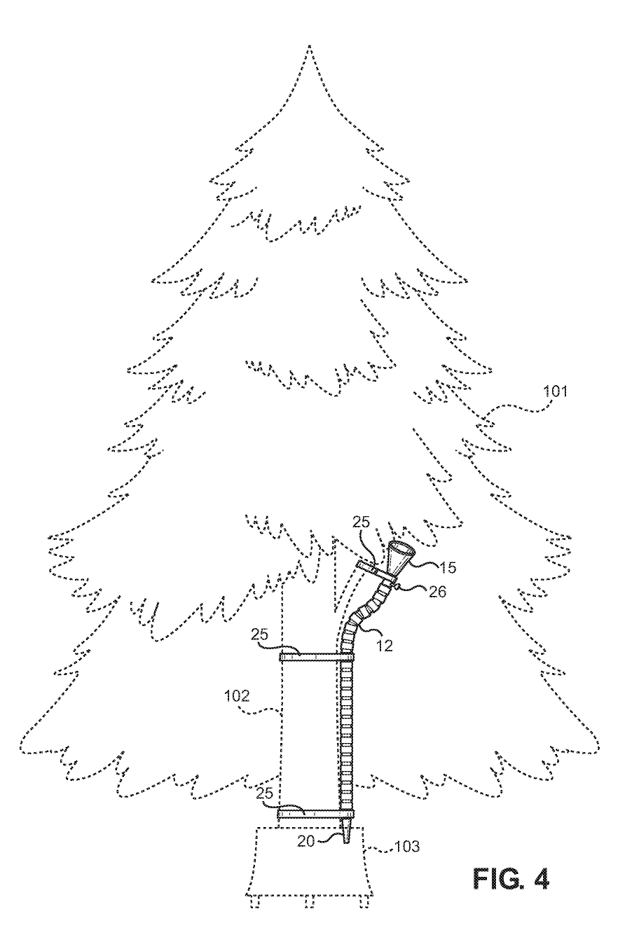

Referring now to FIG. 4, there is shown a side view of the tree watering device secured to a tree. In the shown embodiment, a third fastener 25 is disposed on the elongated body 12 for further securing the device to the tree 101. The elongated body 12 is flexible so that it may be run along the length of the tree trunk 102 and threaded between branches so that is obscured from view. The funnel is secured to the branches of the tree 101 via one fastener 25, while the hollow stake 20 is secured to the trunk 102 of the tree 101, such that the lower end is disposed within the tree stand 103. If the tree stand 103 comprises a pot with soil, the hollow stake 20 can be secured therein via insertion into soil, allowing the device to be used with potted trees as well as Christmas trees. In use, a user may pour water into the funnel 15 when the valve 26 is in a closed position. When the user desires to water the tree, the user simply moves the valve 26 to an open position, causing water stored in the funnel 15 to flow through the elongated body 12 and out of the hollow stake 20, providing water to the base of the tree 101.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A tree watering device, comprising:
an elongated body comprising a channel therethrough,
a funnel having an open upper end disposed on an upper end of the elongated body, the funnel in fluid communication with the channel;
a hollow stake having an open lower end disposed on a lower end of the elongated body, the hollow stake in fluid communication with the channel;
a fastener disposed on the elongated body configured to secure the elongated body to a tree;
a valve disposed on the elongated body and extending into the channel, wherein the valve is configured to selectively allow water to flow from the funnel through the channel and out of the open lower end of the hollow stake.

2. The tree watering device of claim 1, wherein the funnel comprises a sidewall that tapers inwardly from the open upper end to a lower end thereof.

3. The tree watering device of claim 1, wherein the hollow stake comprises a sidewall that tapers inwardly from an upper end to the open lower end thereof.

4. The tree watering device of claim 1, wherein the elongated body comprises flexible tubing.

5. The tree watering device of claim 1, wherein the fastener comprises a first fastener affixed to the funnel and a second fastener affixed to the hollow stake.

6. The tree watering device of claim 5, wherein the first fastener and the second fastener comprise hook and loop material.

7. The tree watering device of claim 1, wherein the valve comprises a pull-out valve having a handle extending outwardly from the elongated body affixed to a stopper disposed within the channel, wherein the pull-out valve is configured to maintain an extended position wherein water is unable to flow through the channel or a retracted position wherein water is able to flow through the channel.

8. The tree watering device of claim 1, wherein the valve comprises a rotating valve having a handle extending outwardly from the elongated body affixed to a stopper disposed within the channel, wherein rotating valve is configured to rotate between an extended position wherein water is unable to flow through the channel or a retracted position wherein water is able to flow through the channel.
